(19) United States
(12) Patent Application Publication
(10) Pub. No.: US 2009/0144107 A1
(43) Pub. Date: Jun. 4, 2009

(54) Multi-level referral system method

(76) Inventor: Min-Liang Tan, Singapore (SG)

Correspondence Address: ANDREW G. DINOVO;DiNOVO PRICE ELLWANGER & HARDY LLP, 7000 N. MOPAC EXPRESSWAY, SUITE 350, AUSTIN, TX, 78731, US

(21) Appl. No.: 11/998,675

(22) Filed: Nov. 30, 2007

(51) Int. Cl. G06Q 30/00; G06F 17/40

(52) U.S. Cl. 705/7; 705/14

(57) ABSTRACT

A system and method are disclosed for referring, educating, and incentivizing sales personnel. An Internet (or intranet) website may be established to allow sales and/or retail associates to sign up with the website for product training or to receive pertinent information from the vendor. The website may test knowledge, convey educational information, and provide incentives to sales personnel to refer other sales personnel to the website where such incentives, such as achievement levels, discounts and free products, are only given to the referrer when the referees or such number of referees are signed up to the site.

### FIELD OF THE INVENTION

The present invention relates generally to the field of sales, and more particularly to sales referral and motivation programs and systems.

### BACKGROUND OF THE INVENTION

Many prior art methods are utilized to learn more about a company's customers, including demographic and related date, so that goods and services may be appropriately and effectively marketed. Traditional forms of getting retail associates to sign up with vendors such as opt-in emails, traditional pen and paper sign-ups, etc.

Despite certain advantages of the foregoing, the prior art methods suffer from certain shortcomings. Identifying information for relevant sales personnel has been difficult to obtain and maintain, insofar as retail chains and companies tend to keep such information confidential. Further, with constant staff turnover among large retailers, prior art methods do not provide reliable and updated personal information of such retail associates.

In view of the foregoing, a system and method are needed for obtaining the personal information, including contact information such as electronic mail addresses, of retail associates for the purposes of product training and communication of information.

### SUMMARY OF THE INVENTION

The system and method of the present invention allow retail personnel or associates to refer other retail associates to voluntarily opt-in for a program to allow vendors to communicate relevant information to them. The system and method of the present invention also allow such referrals to grow organically by turning referees into referrers by providing incentives to have them refer more referees. This program is preferably multi-level, as described below.

More specifically, an Internet (or intranet) website may be established to allow sales and/or retail associates to sign up with the website for product training or to receive pertinent information from the vendor. The website may test knowledge, convey educational information, and provide incentives to sales personnel to refer other sales personnel to the website where such incentives, such as achievement levels, discounts and free products, are only given to the referrer when the referees or such number of referees are signed up to the site. Sales personnel may be associated with an organization manufacturing, distributing or selling the device, or a plurality of such organizations.

### BRIEF DESCRIPTION OF THE DRAWINGS

The foregoing and other advantages of the invention will become apparent upon reading the following detailed description and upon reference to the drawings, wherein:

FIG. 1 illustrates a flowchart of one embodiment of the system and method of the present invention;

FIGS. 2-5 are flowcharts of various embodiments of the system and method of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF PREFERRED EMBODIMENTS

As set forth above, embodiments of the invention provide a system and method for educating disparate sales personnel and enhancing product penetration.

More specifically, embodiments of the invention encompass establishing of an Internet website to allow sales and/or retail associates to sign up with the website for product training or to receive pertinent information from the vendor;

The website may be hosted on one or more servers. The registration functions may be hosted on a separate server for security reasons, though registration and other functionality can be combined if desired. In a preferred embodiment, the servers have associated storage, including a database of all personnel who are involved in the multilevel referral system.

The servers may also generate invitations to potential new candidates. Alternatively, invitations may be initiated manually from public sources of information. The invitation information may be tracked for marketing purposes and the like.

In a preferred embodiment, the website provides incentives to sales personnel to refer other sales personnel to the website where such incentives, such as achievement levels, discounts and free products, are only given to the referrer when the referees or such number of referees are signed up to the site. Sales personnel may be associated with an organization manufacturing, distributing or selling the device, or a plurality of such organizations.

For example, for referrer A to receive a free computer, he may need to refer 3 other retail associates to the program and A is only entitled to receive the computer if there are 3 successful sign-ups. This referral system is a multi level system in which Referrer A may only be entitled to receive additional incentives, i.e. a free mobile phone, when further conditions are fulfilled, i.e. when one of his referees, i.e. Referee B, successfully refers another 3 other referees, and so on and so forth.

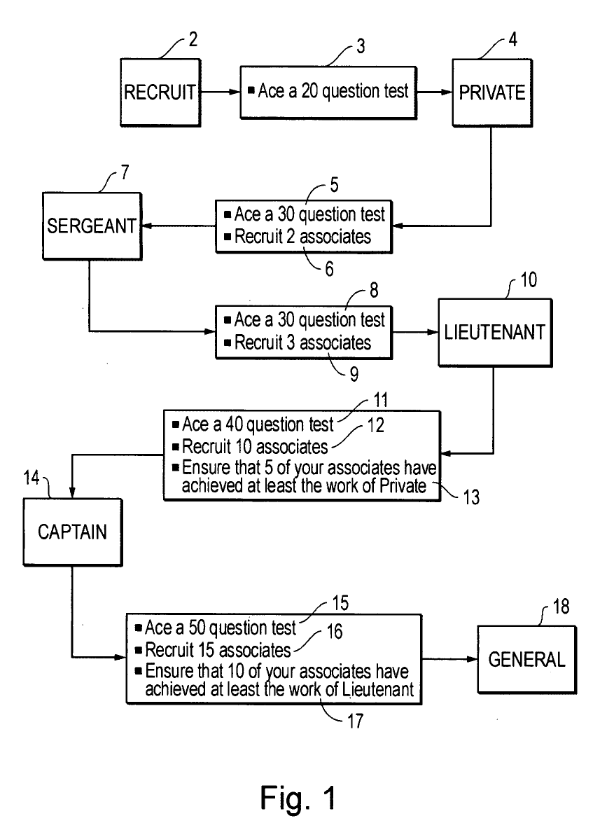

FIG. 1 shows an exemplary embodiment of the present invention, whereby ranks are achieved by sales personnel meeting certain pre-established criteria, including passing tests associated with product knowledge and referring other sales associates. Highest ranks are only obtainable where referred personnel have also achieved preselected criteria, such as a threshold rank.

For example, the candidate registers for a website that has been pre-established by or on behalf of a product provider. Upon registration, the candidate is assigned a rank of “recruit” 2. At that time, the recruit is presented with a knowledge-based test 3 associated with the product. Upon successful completion of the test, the person achieves the rank of “private” 4.

The candidate may continue to climb rank in a multi-level fashion as shown in FIG. 1. More specifically, the private may choose to undertake a more comprehensive test of 30 questions 5. In addition, the private may be required to “recruit” or refer other sales personnel/associates into the system 6. These referrals are preferentially tracked when the additional people register, by being questioned as to the person who has referred them. Alternatively, other mechanisms may be provided, whereby credit may be requested, reviewed and approved by either the referring or referred party.

Upon successful completion of the second test 5 and the system's recordation of 2 referrals 6, the former private receives the rank of sergeant 7. This process continues through third test 8 and additional referral requirements 9, leading to the rank of lieutenant 10.

To attain the rank of captain 14, the following requirements are identified in FIG. 1: successful completion of a 40 question test 11, recruiting ten sales personnel 12, whereby at least 5 of those personnel 13 have themselves obtained the rank of private 4.

To achieve the highest rank, general 18, three additional criteria must be met. First, the captain must achieve a minimum score on a most-comprehensive, 50 question test 15. Second, the captain must have successfully recruited 15 sales personnel to the system 16. Finally, of those who have been recruited within the system, at least 10 of those must have themselves 17 achieved the rank of lieutenant.

The multi-level referral system can be incentive based. In addition to the ranking system described above, products or services may be provided to incentivize sales personnel to seek and attain higher ranks. For example, in the program described in connection with FIG. 1, a product-related t-shirt may be provided to persons obtaining the rank of private 4. Those attaining the rank of sergeant 7 may be provided a mouse pad. Those reaching lieutenant 10 may be provided a computer mouse. Captains 14 may receive a keyboard. Generals 18 may be provided with an integrated audio system. While the specific products sought for the incentive program may of course be varied as appropriate to the products sought to be sold, the general concept involves increasing the value/desirability of those products as higher ranks/levels are obtained.

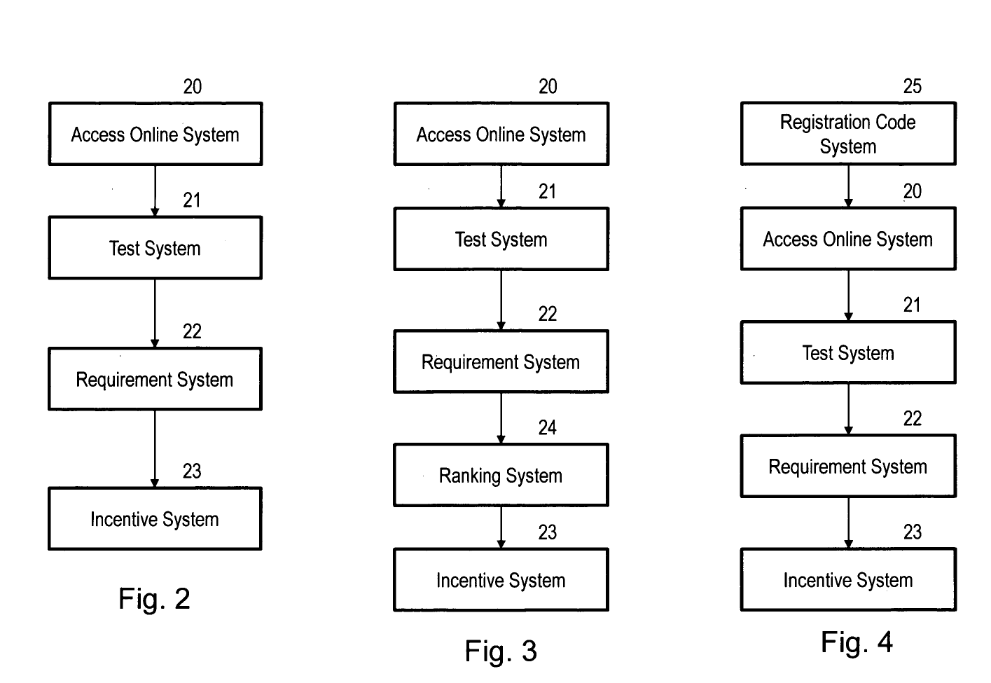

FIGS. 2-5 show the flow of various embodiments of the present invention. As shown in FIG. 2, in one embodiment, candidates can remotely access 20 the online referral system. The test system 21 of the computerized system presents candidates with one or more tests. A requirements system 22 can be accessed by the administrator to create certain requirements, and is used to determine and record whether requirements have been met by a particular candidate. An incentive system 23 will administer providing incentives such as money, discounts, goods or services as appropriate.

Similarly, FIG. 3 includes the same systems, and further includes ranking system 24, which administers the ranking function as noted above. Ranks may be accessible on a password basis, or may be made public as an additional incentive to others to attain higher ranks.

The embodiment disclosed in FIG. 4 does not include ranking system 24, but does include registration code system 25. The registration code system 25 can generate registration codes, which are required by new participants to register with the system. In one embodiment, the registration codes are managed centrally. In an alternative embodiment, each of a plurality of affiliate companies may generate and distribute registration codes for their own employees. Of course, a combination of approaches may also be used.

In an exemplary embodiment, website provider or host can generate a range of 20,000 6-digit alphanumeric codes using a random code generator. The provider can then assign 10,000 codes to direct registration users, who come to the site via printed material/code card. The provider then assigns the remaining 10,000 codes to the referred user database.

Users can receive a “Direct Registration Code” via printed/promotional material (e.g., a code card) and access the website to register a new account with the code. Registered members may receive a referral code from the referral code database via email. This code is retrieved from the range of codes assigned to the referred user database. Registered members can be either direct members or referred members.

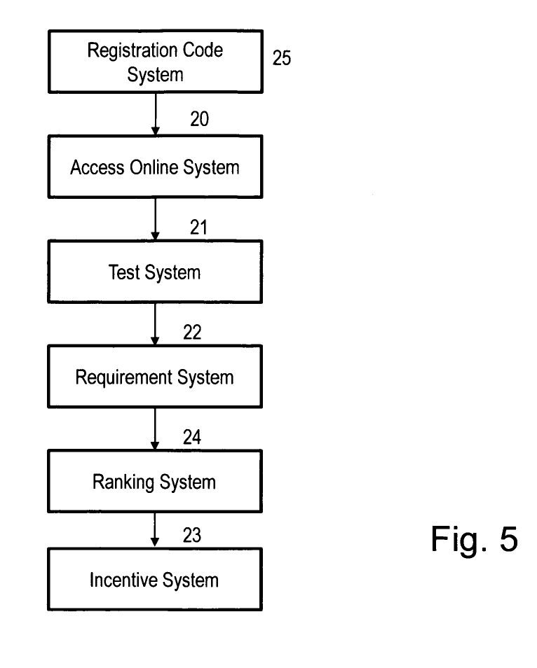

FIG. 5 depicts the multi-level referral system with all components discussed above.

The referral program allows for the organic growth of retail associate sign-ups on a voluntary basis and allows the vendor to build up a database of such sales associates without having to resort to traditional methods of pen and paper or contacting the retail chain management. As a consequence, retain chain management can be bypassed, thereby creating a direct incentive system between a product manufacturer and sales personnel employed by disparate retain organizations.

In one embodiment, the website has associated with it a blog and/or a user discussion forum to provide a sense of community and to exchange ideas about the associated products, including on relevant topics such as sales, product information and performance, service, reliability, and upcoming products.

As noted above, while the present invention has been described with reference to one or more particular embodiments, those skilled in the art will recognize that many changes may be made thereto without departing from the spirit and scope of the present invention. For example, in lieu of product sales, the system and method could be advantageously applied to the sales of services. Each of these embodiments and obvious variations thereof is contemplated as falling within the spirit and scope of the claimed invention, which is set forth in the following claims.

What is claimed is:

1. A method for referring sales personnel to a website promoting the sale of one or more products, comprising:
(a) registering a first salesperson at said website;
(b) determining whether said first salesperson has met a first set of preestablished criteria;
(c) following successful completion of said first set of preestablished criteria, providing said first salesperson with a rank;
(d) determining whether said first salesperson has met a second set of preestablished criteria; and
(e) following completion of said second set of preestablished criteria, providing said first salesperson with a second rank.

2. The method of claim 1, further comprising repeating steps (d) and (e) for a series of subsequent ranks until a final rank is achieved by said first salesperson.

3. The method of claim 1, further comprising rewarding said first salesperson upon achieving said first set of preestablished criteria with merchandise.

4. The method of claim 1, wherein said first set of preestablished criteria do not include a sales goal.

5. The method of claim 1, wherein said first set of preestablished criteria comprises a first test relating to said one or more products.

6. The method of claim 1, wherein said first set of preestablished criteria comprises a referral requirement for the referral of one or more other salespersons to said website.

7. The method of claim 1, further comprising rewarding said first salesperson upon achieving said second set of preestablished criteria with merchandise.

8. The method of claim 1, wherein said second set of preestablished criteria do not include a sales goal.

9. The method of claim 1, wherein said second set of preestablished criteria comprises a second test relating to said one or more products.

10. The method of claim 1, wherein said second set of preestablished criteria comprises a referral requirement for the referral of one or more other salespersons to said website.

11. The method of claim 5, wherein said first test corresponds to a first level of product knowledge, and wherein said second set of preestablished criteria comprises a second test relating to said one or more products, wherein said second test corresponds to a second level of product knowledge.

12. The method of claim 2, wherein said sets of preestablished criteria associated with said first, second and subsequent ranks comprise requirements increasing in difficulty with said ranks.

13. The method of claim 1, further comprising inviting said first salesperson to register with said website prior to said registering step.

14. A computer system for creating a community of salespersons for a product line, comprising:
a website, wherein said website acts as portal to said community of salespersons, said website hosted on one or more servers accessible through the Internet;
a registration center accessible via said website, wherein a plurality of salespersons can register for a multilevel referral program, said multilevel referral program comprising:
a plurality of ranks which each of a plurality of salespersons can seek to obtain; and
a plurality of preestablished criteria associated with said ranks, wherein said preestablished criteria increase in difficulty as rank increases.

15. The computer system of claim 14, wherein said plurality of salespersons are rewarded with merchandise upon achieving one or more of said preestablished criteria associated with said ranks.

16. The computer system of claim 14, wherein said preestablished criteria do not include a sales goal.

17. The computer system of claim 14, wherein said preestablished criteria comprise a first test relating to said one or more products.

18. The computer system of claim 14, wherein said preestablished criteria comprise a referral requirement for the referral of a predetermined number of said salespersons to said website.

19. The computer system of claim 14, wherein said multilevel referral program issues a reward to those of said plurality of salespersons who have achieved a second set of preestablished criteria with merchandise.

20. The computer system of claim 14, wherein said preestablished criteria comprise a referral requirement for the referral of one or more other salespersons to said website.

21. The computer system of claim 14, wherein said one or more servers comprise storage, and wherein said storage comprises a database comprising identifying and rank information relating to each of said plurality of salespersons.

22. The computer system of claim 21, wherein said one or more servers tracks invitations to new candidates.

23. A computerized multi-level referral system comprising:
a website hosted on one or more servers accessible through the Internet;
a test system adapted to test a plurality of candidates for one or more test levels, said plurality of candidates accessing said test system through said website;
a requirement system programmed to determine whether at least some of said plurality of candidates has met one or attainment levels, wherein each of said attainment levels has a set of requirements associated therewith; and
an incentive system programmed to initiate distribution of incentives to one or more of said candidates upon achieving a new attainment level.

24. The computerized multi-level referral system of claim 23, further comprising a ranking system for providing at least some of said plurality of candidates with a rank.

25. The computerized multi-level referral system of claim 23, further comprising a registration code system which generates and accepts a plurality of registration codes, wherein said registration codes are required to register with said multi-level referral system.

26. The computerized multi-level referral system of claim 23, wherein said incentives comprise a product of the company whose goods or services are being sold by said plurality of candidates.

27. The computerized multi-level referral system of claim 23, wherein said incentives comprise a discount to purchase one or more products of a company whose goods or services are being sold by said plurality of candidates.

28. The computerized multi-level referral system of claim 23, wherein said wherein at least some of said candidates are employees of an affiliated company.

29. The computerized multi-level referral system of claim 24, wherein at least some of said sets of requirements comprise having referred a number of candidates who have attained said rank.

30. The computerized multi-level referral system of claim 25, wherein only an associate registered with said computerized multi-level referral system can distribute said registration codes.

31. The computerized multi-level referral system of claim 25, wherein one of said registration codes is transmitted to a prospect.

32. The computerized multi-level referral system of claim 31, wherein product information is transmitted with said one of said registration codes.
